(19) United States
(12) Patent Application Publication
(10) Pub. No.: US 2024/0023142 A1
(43) Pub. Date: Jan. 18, 2024

(54) METHODS AND APPARATUS TO UPDATE MRB CONFIGURATION BY COMMON MULTICAST SIGNALING FOR MBS MULTICAST RECEPTION IN RRC INACTIVE STATE

(71) Applicant: MediaTek Singapore Pte. Ltd., Singapore (SG)

(72) Inventors: Xiaonan Zhang, Beijing (CN); Yuanyuan Zhang, Beijing (CN)

(21) Appl. No.: 18/448,951

(22) Filed: Aug. 13, 2023

Related U.S. Application Data
(63) Continuation of application No. PCT/CN2022/105784, filed on Jul. 14, 2022.

(30) Foreign Application Priority Data
Jul. 14, 2022 (WO) PCT/CN2022/105784
Jun. 13, 2023 (CN) 202310701319.6

(51) Int. Cl. H04W 72/30; H04W 76/27

(52) U.S. Cl. CPC H04W 72/30; H04W 76/27

(57) ABSTRACT

Apparatus and methods are provided for UE to receive multicast services in RRC INACTIVE state. In one novel aspect, the UE joins a multicast session, receives an initial multicast configuration from a serving cell for the multicast, monitors a common multicast signaling for the multicast session in the RRC INACTIVE state and updates the multicast configuration based on the common multicast signaling upon detecting one or more predefined triggering conditions. In one embodiment, the UE updates the multicast configuration without notifying network. In another embodiment, the UE determines to perform a handover to a target cell upon detecting the source channel quality is below a predefined threshold. In one embodiment, the UE performs handover to the target cell after reconfiguring the multicast to the target cell. In one embodiment, the initial multicast configuration is received in an RRC Reconfiguration message or an RRC Release message.

### CROSS REFERENCE TO RELATED APPLICATIONS

This application is filed under 35 U.S.C. §111(a) and is based on and hereby claims priority under 35 U.S.C. §120 and §365(c) from International Application No. PCT/CN2022/105784, titled “METHODS AND APPARATUS TO UPDATE MRB CONFIGURATION BY COMMON MULTICAST SIGNALING FOR MBS MULTICAST RECEPTION IN RRC INACTIVE STATE,” with an international filing date of Jul. 14, 2022. This application claims priority under 35 U.S.C. §119 from Chinese Application Number 202310701319.6, titled “METHODS AND APPARATUS TO UPDATE MRB CONFIGURATION BY COMMON MULTICAST SIGNALING FOR MBS MULTICAST RECEPTION IN RRC INACTIVE STATE,” filed on Jun. 13, 2023. The disclosure of each of the foregoing documents is incorporated herein by reference.

### TECHNICAL FIELD

The disclosed embodiments relate generally to wireless communication, and, more particularly, to update multicast configuration for multicast reception in RRC INACTIVE state.

### BACKGROUND

Various cellular systems, including both 4G/LTE and 5G/NR systems, may provide a multicast functionality, which allows user equipments (UEs) in the system to receive multicast services transported by the cellular system. A variety of applications may rely on communication over multicast transmission, such as live stream, video distribution, vehicle-to-everything (V2X) communication, public safety (PS) communication, file download, and so on. In the legacy system, the multicast service is received by UE in the RRC CONNECTED state. In current NR multicast, UE receives multicast service in RRC CONNECTED, and the reception is indicated and updated by RRC message. With the increasing demand for multicast services, improved efficiency and power saving are desired for multicast services. One improvement is to enable the UE to receive the multicast service in the RRC INACTIVE state. For multicast reception via RRC INACTIVE state, some extra signaling may be needed when the configuration of multicast needs to be updated.

Improvements and enhancements are required for the UE to receive multicast services in the RRC INACTIVE state.

### SUMMARY

Apparatus and methods are provided for the UE to receive multicast services in the RRC INACTIVE state. In one novel aspect, the UE joins a multicast session, receives an initial multicast configuration from a serving cell for the multicast services, monitors a common multicast signaling for the multicast session in the RRC INACTIVE state and updates the multicast configuration based on the common multicast signaling upon detecting one or more predefined triggering conditions. In one embodiment, the common multicast signaling is indicated by the wireless network periodically with updated periodic information. In another embodiment, the common multicast signaling is from the source cell and includes information/indication for neighboring cell multicast configurations. In one embodiment, the UE updates the multicast configuration without notifying the network. In another embodiment, the UE determines to perform a UE-triggered handover to a target cell upon detecting the source channel quality is below a predefined threshold. In one embodiment, the UE performs handover to the target cell after reconfiguring the multicast to the target cell. In one embodiment, the initial multicast configuration is received in a RRC message. In one embodiment, the RRC message carries the initial multicast configuration as either an RRC Reconfiguration message or an RRC Release message.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports the UE receives multicast in RRC INACTIVE state in accordance with embodiments of the current invention.

FIG. 2A illustrates an exemplary NR wireless system with centralized upper layers of NR radio interface stacks in accordance with embodiments of the current invention.

FIG. 2B illustrates an exemplary diagram for top-level functions for the UE to receive multicast services in RRC INACTIVE state in accordance with embodiments of the current invention.

FIG. 3 illustrates an exemplary diagram for UE to receive initial multicast configuration for the UE to receive multicast services in the RRC INACTIVE state in accordance with embodiments of the current invention.

FIG. 4 illustrates an exemplary diagram for UE to update the multicast configuration in the RRC INACTIVE state in accordance with embodiments of the current invention.

FIG. 5 illustrates an exemplary message sequence diagram for the UE to receive initial multicast configuration for the UE to receive multicast services in the RRC INACTIVE state in accordance with embodiments of the current invention.

FIG. 6 illustrates an exemplary message sequence diagram for the UE to make mobility decision and performs handover in the RRC INACTIVE state in accordance with embodiments of the current invention.

FIG. 7 illustrates an exemplary flow chart for the UE to receive multicast services in the RRC INACTIVE state in accordance with embodiments of the current invention.

### DETAILED DESCRIPTION

Reference will now be made in detail to some embodiments of the invention, examples of which are illustrated in the accompanying drawings.

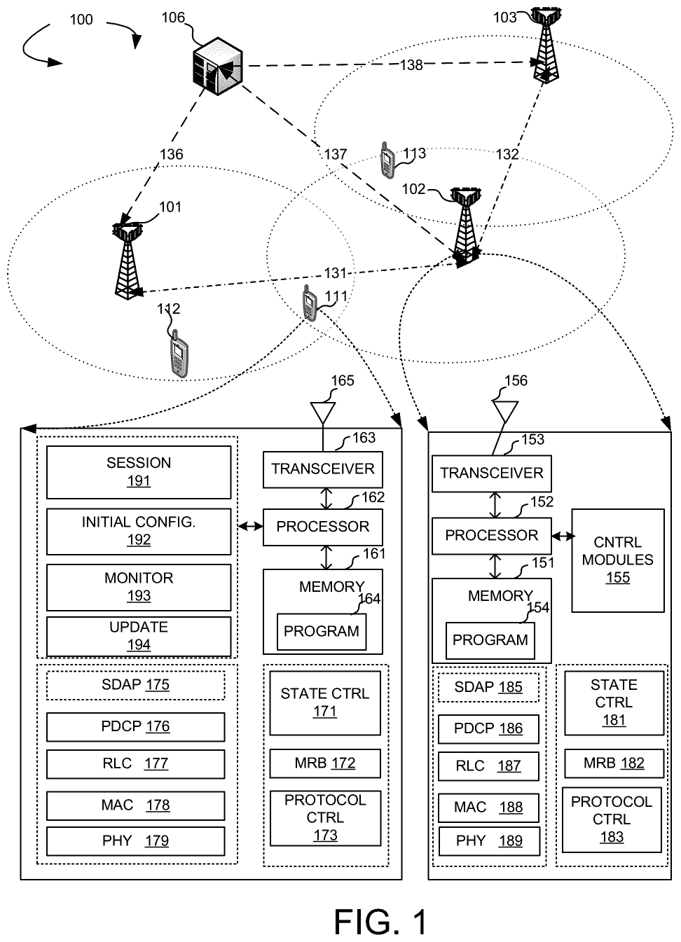

FIG. 1 is a schematic system diagram illustrating an exemplary wireless network that supports the UE receives multicast in RRC INACTIVE state in accordance with embodiments of the current invention. In certain scenarios, such as high load/congestion scenario, the UE is configured to receive multicast services in RRC INACTIVE state. It can also improve the multicast services in terms of power saving, service coverage and spectrum efficiency. Wireless system 100 includes one or more fixed base infrastructure units forming a network distributed over a geographical region. As an example, base stations/gNBs 101, 102, and 103 serve a number of mobile stations, such as UE 111, 112, and 113, within a serving area, for example, a cell, or within a cell sector. In some systems, one or more base stations are coupled to a controller forming an access network that is coupled to one or more core networks, through a network entity, such as network entity 106. gNB 101, gNB 102 and gNB 103 are base stations in NR, the serving area of which may or may not overlap with each other. As an example, UE or mobile station 112 is only in the service area of gNB 101 and connected with gNB101. UE 112 is connected with gNB 101 only. UE 111 is in the overlapping service area of gNB 101 and gNB 102 and may switch back and forth between gNB 101 and gNB 102. UE 113 is in the overlapping service area of gNB 102 and gNB 103 and may switch back and forth between gNB 102 and gNB 103. Base stations, such as gNB 101, 102, and 103 are connected the network through network entities, such as network entity 106 through NG connections, such as 136, 137, and 138, respectively. Xn connections 131 and 132 connect non-co-located receiving base units. Xn connection 131 connects gNB 101 and gNB 102. Xn connection 132 connects gNB 102 and gNB 103. These Xn/NG connections can be either ideal or non-ideal.

In one novel aspect, the UE receives the multicast services in the RRC INACTIVE state. The UE receives the initial multicast configuration after joining the multicast session. The UE receives the initial multicast configuration from the serving cell through an RRC message. In one embodiment, a signaling indicating the configurations for multicast is common to all UEs receiving multicast service in the cell. The signaling indicating the configurations for multicast may also be referred to as a common RRC message, a common multicast message, a common RRC signaling, or a common multicast signaling used in the art. In one embodiment, the UE performs reconfiguration for the multicast configuration in the RRC INACTIVE state. In another embodiment, the UE makes mobility decision for the multicast data reception based on the channel quality of the serving cell. The UE monitors common multicast message to obtain the neighboring cell/target cell information. The UE handover to the target cell in the RRC INACTIVE state after reconfiguring the multicast to the target cell.

FIG. 1 further illustrates simplified block diagrams of a base station and a mobile device/UE that supports the UE receives multicast in RRC INACTIVE state. gNB 102 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 102. Memory 151 stores program instructions and data 154 to control the operations of gNB 102. gNB 102 also includes a set of control modules 155 that carry out functional tasks to communicate with mobile stations. An RRC state controller 181 performs access control for the UE. An multicast radio bearer(MRB) controller 182 performs control function to establish/add, reconfigure/modify, and release/remove an MRB based on different sets of conditions for MRB establishment, reconfiguration and releasement. A protocol stack controller 183 manages to add, modify or remove the protocol stack for the MRB. The protocol stack includes PDCP layer 186, RLC layer 187, MAC layer 188 and PHY layer 189, and optionally SDAP layer 185.

UE 111 has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown) for different frequency bands. RF transceiver 163 also converts received baseband signals from processor 162, converts them to RF signals, and sends out to antenna 165. Processor 162 processes the received baseband signals and invokes different functional modules to perform features in the UE 111. Memory 161 stores program instructions and data 164 to control the operations of the UE 111. Antenna 165 sends uplink transmission and receives downlink transmissions to/from antenna 156 of gNB 102.

UE 111 also includes a set of control modules that carry out functional tasks. These control modules can be implemented by circuits, software, firmware, or a combination of them. An RRC State controller 171 controls UE RRC state according to network's command and UE conditions. UE supports the following RRC states, RRC IDLE, RRC CONNECTED and RRC INACTIVE. In one embodiment, UE can receive the multicast services in RRC INACTIVE state. The UE applies the MRB establishment procedure to start receiving a session of a broadcast service it has joined. The UE applies the MRB release procedure to stop receiving a session. An MRB controller 172 controls to establish/add, reconfigure/modify and release/remove an MRB based on different sets of conditions for MRB establishment, reconfiguration and releasement. A protocol stack controller 173 manages to add, modify, or remove the protocol stack for the MRB. The protocol Stack includes PDCP layer 176, RLC layer 177, MAC layer 178 and PHY layer 179. In one embodiment, the SDAP layer 175 is optionally configured. A session module 191 joins a multicast session in a wireless network. An initial configuration module 192 receives an initial multicast configuration from a serving cell in the wireless network, wherein the initial multicast configuration is for a multicast configuration of the UE to receive the multicast session in a RRC INACTIVE state. A monitor module 193 monitors a common multicast signaling for the multicast session from the wireless network in the RRC INACTIVE state. An update module 194 updates the multicast configuration based on the common multicast signaling upon detecting one or more predefined triggering conditions.

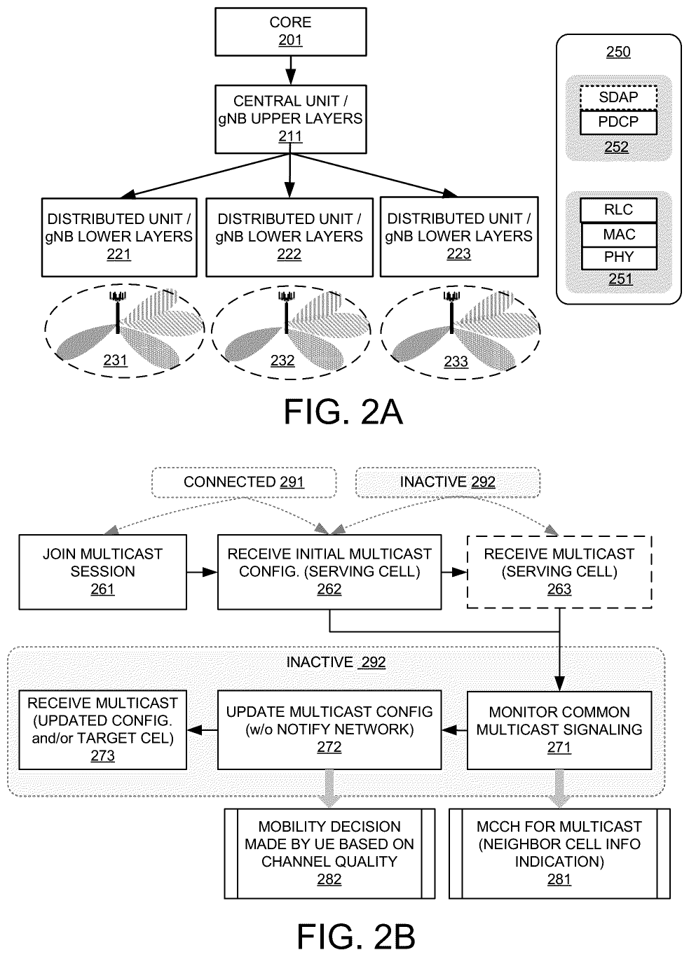

FIG. 2A illustrates an exemplary NR wireless system with centralized upper layers of NR radio interface stacks in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization, and jitter. In one embodiment, SDAP and PDCP layer are located in the CU, while RLC, MAC and PHY layers are located in the DU. A Core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 221 with gNB lower layer 251. Distributed units 221, 222, and 223 each corresponds to a cell 231, 232, and 233, respectively. The DUs, such as 221, 222 and 223 include gNB lower layers 251. In one embodiment, gNB lower layers 251 include the PHY, MAC and the RLC layers.

FIG. 2B illustrates an exemplary diagram for top-level functions for the UE to receive multicast services in RRC INACTIVE state in accordance with embodiments of the current invention. In one novel aspect, the UE receives multicast services in the RRC INACTIVE state. The UE further reconfigures the multicast configuration in the INACTIVE state without notifying the network. At step 261, the UE joins the multicast session in the RRC CONNECTED state 291. At step 262, the UE receives the initial multicast configuration from the serving cell. In one embodiment, the initial multicast configuration is sent to the UE by RRC message. In one embodiment, the RRC message is an RRC Reconfiguration message. In another embodiment, the RRC message is an RRC Release message. The UE upon receiving the initial multicast configuration applies the configuration in either RRC CONNECTED state 291 or RRC INACTIVE state 292. At step 263, the UE starts receiving the multicast data in the RRC INACTIVE state. In some scenarios, the UE performs reconfiguration before receiving the multicast data. In RRC INACTIVE state 292, the UE monitors common multicast channel (271). In one embodiment, the common multicast channel is a multicast control channel (MCCH). In one embodiment (281), The common multicast channel from the serving cell sends the neighboring cell information and other updated configuration. At step 272, the UE updates the multicast configuration based on the information in the common multicast channel. In one embodiment (282) the UE makes mobility decision based on channel qualities without notifying the network. The channel quality includes the channel quality of the serving cell. At step 273, the UE receives MBS with updated configuration and/or in the new target cell.

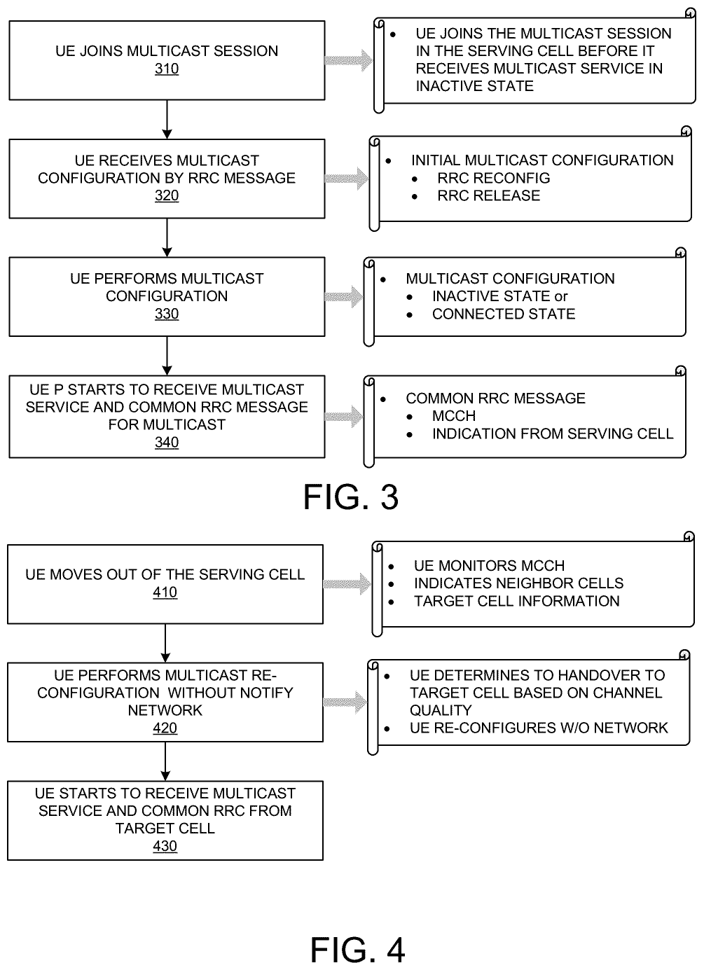

FIG. 3 illustrates an exemplary diagram for UE to receive initial multicast configuration for the UE to receive multicast services in the RRC INACTIVE state in accordance with embodiments of the current invention. At step 310, the UE joins the multicast session in the serving cell. In one embodiment, the UE joins the multicast session before it can receive the multicast services in RRC INACTIVE state. At step 320, the UE receives multicast configuration by RRC message. In one embodiment, the RRC message indicates MRB and/or multicast signaling radio bearer (MSRB) configuration. In one embodiment, the RRC message is the RRC Reconfiguration message. In another embodiment, the RRC message is the RRC Release message. At step 330, the UE performs the multicast configuration, including MRB and/or MSRB, according to the information from RRC message. In one embodiment, UE performs the configuration when UE is in RRC CONNECTED state. In one embodiment, UE performs the configuration when UE is in RRC INACTIVE state. After UE performs the multicast configuration, at step 340, the UE starts to receive multicast service and common RRC message for multicast. In one embodiment, the common RRC message is the MCCH signaling. In one embodiment, the MCCH indicates neighbor cell multicast information.

FIG. 4 illustrates an exemplary diagram for UE to update the multicast configuration in the RRC INACTIVE state in accordance with embodiments of the current invention. When UE is receiving multicast services in RRC INACTIVE state and moving out of the serving cell, UE may perform multicast configuration toward the target cell without notifying the network. At step 410, the UE moves out of the serving cell. The UE in the RRC INACTIVE state monitors the MCCH, which indicates neighbor cell information. The UE may also obtain the target cell information through neighbor cell signaling. In one embodiment, the information for the neighbor cell multicast configuration is indicated by the common RRC message from the source cell. At step 420, the UE performs multicast reconfiguration without notifying the network. The UE determines to perform handover to a target cell based on channel quality detected by the UE. In one embodiment, the channel quality is the source cell channel quality. The UE triggers handover to the target cell by obtaining the target cell multicast configuration and reconfigures the multicast configuration to the target cell. At step 430, the UE starts to receive multicast service and common RRC message for multicast from the target cell.

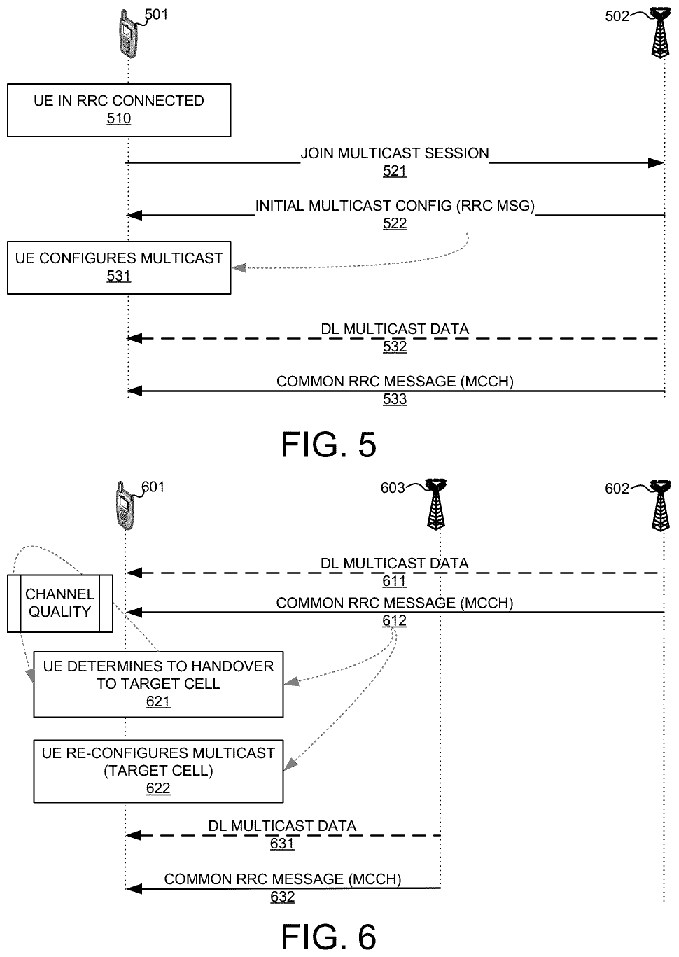

FIG. 5 illustrates an exemplary message sequence diagram for the UE to receive initial multicast configuration for the UE to receive multicast services in the RRC INACTIVE state in accordance with embodiments of the current invention. When UE joins multicast session, UE receives RRC message to configure MRB and/or MSRB. In one embodiment, the RRC message is RRCReconfiguration message. In one embodiment, the RRC message is RRCRelease message. Then UE performs the MRB and MSRB configuration according to the information from RRC message. In one embodiment, UE performs the configurations before UE switching to RRC INACTIVE state. In one embodiment, UE performs the configurations after UE switching to RRC INACTIVE state. At step 510, UE 501 is in the RRC CONNECTED state with serving cell gNB 502. At step 521, the UE joins the multicast session with source gNB 502. At step 522, source gNB 502 sends initial multicast configuration via RRC message to UE 501. At step 531, UE 501 configures the multicast configuration based on the RRC message received from gNB 502. In one embodiment, the RRC message from gNB 502 is the RRC Reconfiguration message, which carries the multicast configuration. In another embodiment, the RRC message from gNB 502 is the RRC Release message, which carries the multicast configuration. In one embodiment, the UE performs the multicast configuration in the RRC CONNECTED state. In another embodiment, the UE performs the multicast configuration in the RRC INACTIVE state. When UE 501 switches to RRC INACTIVE state and finishes the preparation for the multicast reception, at step 532, UE 501 receives the multicast data. At step 533, UE 501 receives common multicast signaling from the network. In one embodiment, the common multicast signaling is indicated by network periodically, and network updates the signaling periodically. In one embodiment, the common multicast signaling indicates the multicast configuration (MRB and MSRB) of the serving cell and neighbor cells.

FIG. 6 illustrates an exemplary message sequence diagram for the UE to make mobility decision and performs handover in the RRC INACTIVE state in accordance with embodiments of the current invention. At step 611, UE 601 in RRC INACTIVE state receives multicast DL data from source cell of gNB 602. At step 612, UE 601 monitors and receives common RRC multicast signaling from source cell gNB 602. When UE receives the multicast data and common multicast signaling in RRC INACTIVE state from serving cell, UE may switch to another cell when conditions are met. At step 621, the UE determines to handover to target cell, such as target cell with gNB 603. In one embodiment, the trigger for this procedure is similar to the legacy handover cases, which can be the trigger of UE sends the measurement report to the network. In one embodiment, the trigger for this procedure is new defined and based on the channel quality of the serving cell. When the condition is met, such as when the serving cell channel quality is below a predefined threshold, at step 622, UE 601 performs the multicast reconfiguration toward the target cell. In one embodiment, the information for the target cell multicast configuration is indicated by the common RRC message. In one embodiment, the common RRC message is from the source cell. After UE 601 performs MRB and/or MSRB configuration towards target cell, UE continues to receive multicast data and common RRC message. At step 631, UE 601 receives DL multicast data from target cell gNB 603. At step 632, UE 601 receives common RRC message from the target cell gNB 603. In one embodiment, the common RRC message for the multicast is the MCCH signaling. In one embodiment, the common RRC messages are different among different cells, which include the configuration for each neighboring cell multicast, respectively.

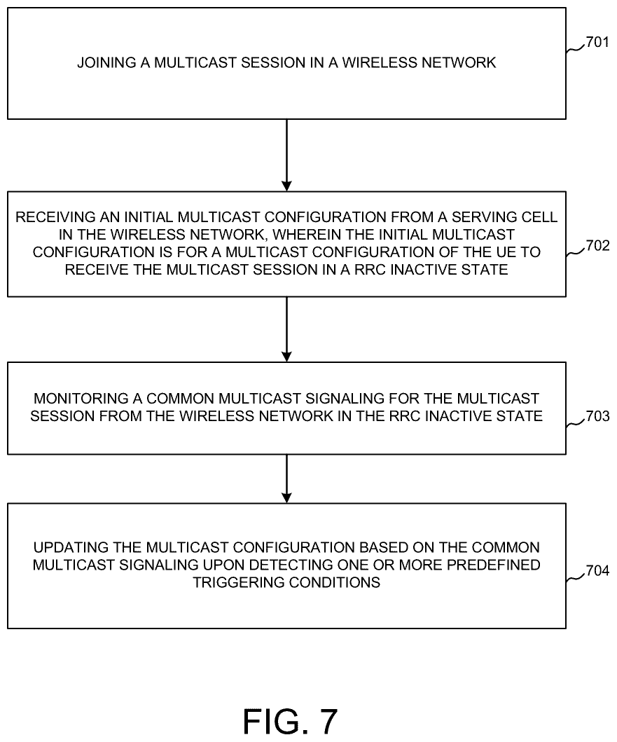

FIG. 7 illustrates an exemplary flow chart for the UE to receive multicast services in the RRC INACTIVE state in accordance with embodiments of the current invention. At step 701, the UE joins a multicast session in a wireless network. At step 702, the UE receives an initial multicast configuration from a serving cell in the wireless network, wherein the initial multicast configuration is for a multicast configuration of the UE to receive the multicast session in a RRC INACTIVE state. At step 703, the UE monitors a common multicast signaling for the multicast session from the wireless network in the RRC INACTIVE state. At step 704, the UE updates the multicast configuration based on the common multicast signaling upon detecting one or more predefined triggering conditions.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE), comprising:
joining a multicast session in a wireless network;
receiving an initial multicast configuration from a serving cell in the wireless network, wherein the initial multicast configuration is for a multicast configuration of the UE to receive the multicast session in a RRC INACTIVE state;
monitoring a common multicast signaling for the multicast session from the wireless network in the RRC INACTIVE state; and
updating the multicast configuration based on the common multicast signaling upon detecting one or more predefined triggering conditions.

2. The method of claim 1, wherein the common multicast signaling is indicated by the wireless network periodically with updated periodical information.

3. The method of claim 1, wherein the common multicast signaling is from the serving cell and includes information for neighboring cell multicast configuration.

4. The method of claim 1, wherein the updating the multicast configuration is performed by the UE without notification to the wireless network.

5. The method of claim 1, wherein the one or more predefined triggering conditions include a UE-triggered handover to a target cell.

6. The method of claim 5, wherein the UE performs the UE-triggered handover upon detecting one or more channel quality measurements of the serving cell is below corresponding predefined threshold.

7. The method of claim 5, wherein the UE continues receiving common multicast signaling from the multicast session in the target cell based on the updated multicast configuration.

8. The method of claim 1, wherein the initial multicast configuration is received by a radio resource control (RRC) message.

9. The method of claim 8, wherein the UE performs the multicast configuration based on the RRC message before switching to the RRC INACTIVE state.

10. The method of claim 8, wherein the UE performs the multicast configuration based on the RRC message after switching to the RRC INACTIVE state.

11. The method of claim 8, wherein the RRC message is an RRC Reconfiguration or an RRC Release message.

12. The method of claim 1, wherein the common multicast signaling is delivered to the UE by an RRC message.

13. A user equipment (UE), comprising:
a transceiver that transmits and receives radio frequency (RF) signal in a wireless network;
a session module that joins a multicast session in a wireless network;
an initial configuration module that receives an initial multicast configuration from a serving cell in the wireless network, wherein the initial multicast configuration is for a multicast configuration of the UE to receive the multicast session in a RRC INACTIVE state;
a monitor module that monitors a common multicast signaling for the multicast session from the wireless network in the RRC INACTIVE state; and
an update module that updates the multicast configuration based on the common multicast signaling upon detecting one or more predefined triggering conditions.

14. The UE of claim 13, wherein the common multicast signaling is indicated by the wireless network periodically with updated periodical information.

15. The UE of claim 13, wherein the common multicast signaling is from the serving cell and includes information for neighboring cell multicast configuration.

16. The UE of claim 13, wherein the update module updates the multicast configuration is performed by the UE without notification to the wireless network.

17. The UE of claim 13, wherein the one or more predefined triggering conditions include a UE-triggered handover to a target cell, and wherein the UE performs the UE-triggered handover upon detecting one or more channel quality measurements of the serving cell is below corresponding predefined threshold.

18. The UE of claim 17, wherein the UE continues receiving common multicast signaling from the multicast session in the target cell based on the updated multicast configuration.

19. The UE of claim 13, wherein the initial multicast configuration is received by a radio resource control (RRC) message, and wherein the RRC message is an RRC Reconfiguration or an RRC Release message.

20. The UE of claim 13, wherein the common multicast signaling is delivered to the UE by an RRC message.
